(19) United States
(12) Patent Application Publication
(10) Pub. No.: US 2018/0369070 A1
(43) Pub. Date: Dec. 27, 2018

(54) PERSONALIZED, TAMPER-RESISTANT PILL DISPENSER DEVICE AND METHOD

(71) Applicant: THE JOHNS HOPKINS UNIVERSITY, Baltimore, MD (US)

(72) Inventors: Andrea Gielen, Ellicott City, MD (US); Megan Elizabeth Carney, Orlando, FL (US); Joseph C. Hajj, Boca Raton, FL (US); Joseph Heaney, Oyster Bay, NY (US); Welles Sakmar, Madison, CT (US); Iulian Ioan Iordachita, Lutherville, MD (US); Nathan W. Scott, Baltimore, MD (US); Soraya J. Bailey, Baltimore, MD (US)

(21) Appl. No.: 15/737,034

(22) PCT Filed: Jun. 17, 2016
(86) PCT No.: PCT/US2016/038027

§ 371 Date: Dec. 15, 2017

Related U.S. Application Data
(60) Provisional application No. 62/180,975, filed on Jun. 17, 2015.

(51) Int. Cl. A61J 7/00; A61J 7/04

(52) U.S. Cl. CPC A61J 7/0076; B65D 83/0409; A61J 7/0481; A61J 7/0427

(57) ABSTRACT

A tamper-resistant, handheld pill dispenser includes a housing including a container to hold a plurality of pills and an opening on a side of the housing. The opening is sized sufficiently to deposit the pills into the container. The dispenser also includes a locking assembly in the opening, and a delivery channel sufficient to pass a pill therethrough. The delivery channel extends from the container to an exterior of the dispenser. The dispenser also includes a user input device on an exterior of the housing and a dispensing mechanism within the dispenser adjacent to the container. The locking assembly can open and close the opening in the housing to restrict access to the container through the opening by unauthorized users. The dispensing mechanism can dispense a pill from the container to the exterior of the dispenser via the delivery channel when activated by an authorized user of the pill dispenser.

### CROSS REFERENCE TO RELATED APPLICATIONS

This application claims the benefit of U.S. Provisional Patent Application No. 62/180,975 filed Jun. 17, 2015, which is incorporated by reference herein, in its entirety.

### GOVERNMENT SUPPORT

The present invention was made with government support under 1R49CE 002466-01, awarded by the Center for Disease Control, National Center for Injury Prevention and Control. The government has certain rights in the present invention.

### FIELD OF THE INVENTION

The present invention relates generally to medical devices. More particularly, the present invention relates to a personalized, tamper-resistant pill dispenser, and methods of using the same.

### BACKGROUND OF THE INVENTION

According to the Centers for Disease Control (CDC), 15,000 people die yearly of prescription painkiller overdoses. In 2010, 1 in 20 people in the US used prescription painkillers for nonmedical reasons. Enough prescription painkillers were prescribed in 2010 to medicate every American adult around-the-clock for a month.

These facts show that this is a huge problem, and there is a need for a device that helps reduce the amount of overdose deaths from prescription opioids. Products currently available are costly and cumbersome. In addition, products currently available are not completely tamper proof, with materials and locks that can be broken and breached. Attackers/Un-authorized users are often teenagers/young adults using household tools to attempt to break into device.

Therefore, it would be advantageous to provide a personalized, tamper-resistant pill dispenser, and methods of using the same.

### SUMMARY OF THE INVENTION

The foregoing needs are met, to a great extent, by the present invention, wherein in one aspect a tamper-resistant, handheld pill dispenser includes a housing including a container defining an interior space sized to hold a plurality of pills, and an opening on a side of the housing. The opening is sized sufficiently to deposit the plurality of pills into the container. The dispenser includes a locking assembly disposed in the opening. The dispenser includes a delivery channel sized with dimensions sufficient to pass a pill of the plurality of pills therethrough. The delivery channel is arranged to extend from the container to an exterior of the pill dispenser. The dispenser includes a user input device on an exterior of the housing, and a dispensing mechanism disposed within the pill dispenser adjacent to the container. The locking assembly is configured to selectively open and close the opening in the housing, and is configured to restrict access to the container through the opening by unauthorized users. The dispensing mechanism is also configured to dispense a pill of the plurality of pills from the container to the exterior of the pill dispenser via the delivery channel, and to dispense the pill when activated by an authorized user of the pill dispenser.

In accordance with an aspect of the present invention, the container includes a spring-loaded cartridge configured to hold the pills. The dispensing mechanism includes a microcontroller operatively connected to the user input device. The dispensing mechanism includes a motor operatively controlled by the microcontroller and configured to transfer a pill from the container to the delivery channel when activated. The microcontroller is configured to activate the motor when a predetermined signal is received from the user input device. The dispensing mechanism further includes a transfer disc coupled to the motor and having a pill-receiving portion sized to at least partially receive a pill to be dispensed, the transfer disc being configured to be rotated by the motor. The pill to be dispensed is transferred from the container to the delivery channel by carried within the pill-receiving portion as the transfer disc is rotated by the motor. The user input device is a biometric sensor. The biometric sensor is a fingerprint scanner. The pill dispenser is configured to dispense pills in a predetermined dosage when activated by the authorized user. The dispensing mechanism is configured to not dispense the pill when activated by an unauthorized user of the pill dispenser. A light emitting diode (LED) can also be included.

In accordance with another aspect of the present invention, a method of storing pills in a tamper-resistant, handheld pill dispenser includes storing a plurality of pills within a container, the container having an opening for loading the plurality of pills into the container. The method includes restricting access to the opening of the container with a locking assembly and providing a user input device on an exterior of the pill dispenser. The method also includes providing a dispensing mechanism configured to receive a signal from the user input device and, when a predetermined signal is received, to dispense a pill of the plurality of pills from the container to an exterior of the pill dispenser.

In accordance with still another aspect of the present invention, a spring-loaded cartridge configured to hold the pills is provided. The method includes providing a microcontroller operatively connected to the user input device and providing a motor operatively controlled by the microcontroller and configured to transfer a pill from the container to the delivery channel when activated. The microcontroller is configured to activate the motor when a predetermined signal is received from the user input device. The method includes providing a transfer disc coupled to the motor and having a pill-receiving portion sized to at least partially receive a pill to be dispensed, the transfer disc being configured to be rotated by the motor. The pill to be dispensed is transferred from the container to the delivery channel by carried within the pill-receiving portion as the transfer disc is rotated by the motor. The method includes providing a biometric sensor as the user input device. The biometric sensor can take the form of a fingerprint scanner. The method includes providing the pill dispenser being configured to dispense pills in a predetermined dosage when activated by the authorized user. A pill is not dispensed when activated by an unauthorized user of the pill dispenser. An LED is included for indicating when the pill dispenser is activated. A key is provided such that the device can be unlocked by a pharmacy. A delay between recognition of a user input and dispensing the pill can also be provided.

### BRIEF DESCRIPTION OF THE DRAWINGS

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIG. 1 illustrates a partially sectional view of a tamper-resistant, handheld pill dispenser, according to an embodiment of the present invention.

FIG. 2A illustrates a perspective view of the tamper-resistant, handheld pill dispenser, according to an embodiment of the present invention.

FIG. 2B illustrates an exploded view of the tamper-resistant, handheld pill dispenser of FIG. 2A.

FIGS. 3A-3D illustrate a pharmacist loading sequence for the tamper-resistant, handheld pill dispenser, according to an embodiment of the present invention.

FIGS. 4A and 4B illustrate a patient dispensing sequence for the tamper-resistant, handheld pill dispenser, according to an embodiment of the present invention.

FIG. 5 illustrates a partially sectional view of the tamper-resistant, handheld pill dispenser, according to an embodiment of the present invention.

FIGS. 6A and 6B illustrate exploded views of the tamper-resistant, handheld pill dispenser, according to an embodiment of the present invention.

FIGS. 7A and 7B illustrates exploded views of the tamper-resistant, handheld pill dispenser, according to an embodiment of the present invention.

FIG. 8 illustrates a sectional and schematic view of the tamper-resistant, handheld pill dispenser and pill movement through the device, according to an embodiment of the present invention.

FIG. 9A illustrates a side view of a location of electronics within the tamper-resistant, handheld pill dispenser, according to an embodiment of the present invention.

FIG. 9B illustrates a perspective view of electronics within the tamper-resistant, handheld pill dispenser, according to an embodiment of the present invention.

FIG. 9C illustrates a schematic diagram of electronics within the tamper-resistant, handheld pill dispenser, according to an embodiment of the present invention.

FIGS. 10A-10C illustrate views of a cap and electronics housing for the tamper-resistant, handheld pill dispenser, according to an embodiment of the present invention.

FIGS. 11A-11C illustrate views of pill storage for within the tamper-resistant, handheld pill dispenser, according to an embodiment of the present invention.

FIG. 12 illustrates a connector, according to an embodiment of the present invention.

FIGS. 13A and 13B illustrate views of a locking mechanism and a pill dispensation mechanism, according to an embodiment of the present invention.

FIGS. 14A and 14B illustrate views of the locking mechanism, according to an embodiment of the present invention.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

An embodiment in accordance with the present invention provides a tamper-resistant, handheld pill dispenser includes a housing including a container to hold a plurality of pills and an opening on a side of the housing. The opening is sized sufficiently to deposit the pills into the container. The dispenser also includes a locking assembly in the opening, and a delivery channel sufficient to pass a pill therethrough. The delivery channel extends from the container to an exterior of the dispenser. The dispenser also includes a user input device on an exterior of the housing and a dispensing mechanism within the dispenser adjacent to the container. The locking assembly can open and close the opening in the housing to restrict access to the container through the opening by unauthorized users. The dispensing mechanism can dispense a pill from the container to the exterior of the dispenser via the delivery channel when activated by an authorized user of the pill dispenser.

There is a need for a personalized and tamper-resistant device that will dispense the proper dose of medicine or pills at the proper time to the authorized user. Embodiments of the invention provide a pill dispenser that reduces unauthorized access to opioid pain relievers or other medicines or controlled substances. In an embodiment, only the pharmacist can unlock the device to load the pills. It has more features and portability and will be less expensive to produce than other products on the market. Other features, objects and embodiments will be apparent from the description, claims and drawings.

In an embodiment, the pharmacist unlocks the device and inserts a supply of medication for a certain period (e.g., a one-month supply) and programs the device for the specific patient. When the patient scans his or her thumbprint at the proper time, the proper dose will be dispensed. The product cannot be broken into by using a hammer or drill.

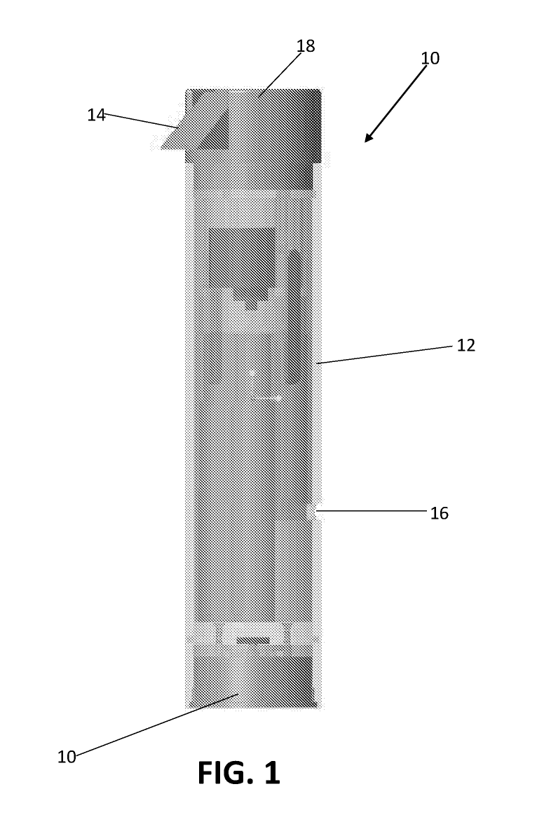

FIG. 1 illustrates a partially sectional view of a tamper-resistant, handheld pill dispenser, according to an embodiment of the present invention. As illustrated in FIG. 1, the device 10 includes a housing 12 and a region for scanning a fingerprint 14, such as a thumbprint. The region for scanning a fingerprint 14 can also take the form of any other suitable biometric sensor known to or conceivable by one of skill in the art. The device 10 includes a pill dispensing slot 16. While the pill dispensing slot 16 is positioned on a side of the device in FIG. 1, it should be noted that the pill dispensing slot 16 can be positioned anywhere, known to or conceivable to one of skill in the art. The device 10 also includes a cap 18 and a locking bottom 20. The device 10 is formed from materials that are strong, light, and tamper-resistant. Therefore, the device 10 is formed from materials that resist actions such as hammering, sawing, prying, and melting.

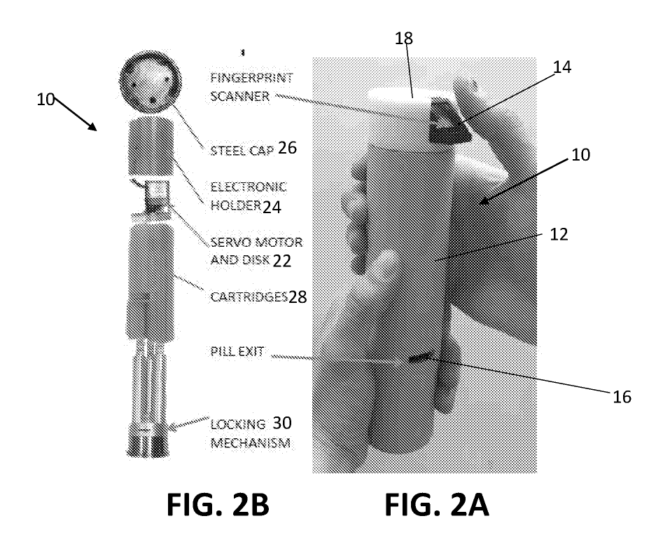

FIG. 2A illustrates a perspective view of the tamper-resistant, handheld pill dispenser, according to an embodiment of the present invention, and FIG. 2B illustrates an exploded view of the tamper-resistant, handheld pill dispenser of FIG. 2A. FIG. 2A illustrates the device 10 having the housing 12. The device 10 includes the region for scanning a fingerprint 14. As illustrated in FIG. 2A, the user places a thumb on the region for scanning a fingerprint 14. Once the fingerprint is verified, a pill can be dispensed from the pill dispensing slot 16. The pill dispensing slot 16 is sized such that a number of different pill sizes and designs can be dispensed from the device. Any size or shape for the pill dispensing slot known to or conceivable by one of skill in the art can be used. As illustrated in FIG. 2B, a servo motor 22 is disposed within housing 12. The servo motor 22 can receive input from the fingerprint scanner and actuates the dispensation of the pill. The servo motor 22 is disposed within an electronic holder 24, which is secured within the device by steel cap 26. Any other suitable material known to or conceivable to one of skill in the art can also be used. The servo motor 22 is disposed in contact with pill cartridges 28, such that the pills can be dispensed. Locking mechanism 30 prevents the pills from being removed from the device once they are loaded by a pharmacist. Outer housing 12 surrounds all of these components, as illustrated in FIG. 2A. The device 10 thereby reduces the number of overdose deaths from prescription drug or opioid abuse, because pills can only be dispensed when a correct fingerprint is scanned. Further, the device 10 can only work over a desired time-frame, such as the time period for which the drugs are prescribed (e.g., a 30-day time frame).

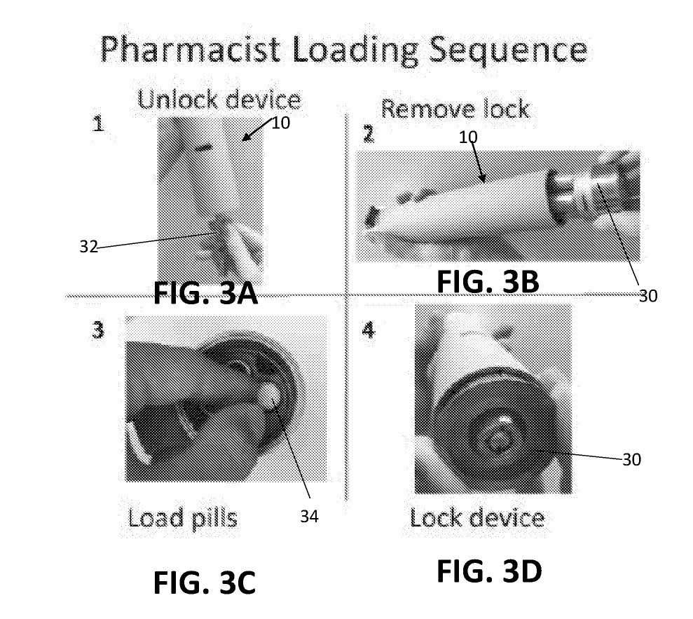

FIGS. 3A-3D illustrate a pharmacist loading sequence for the tamper-resistant, handheld pill dispenser, according to an embodiment of the present invention. In FIG. 3A, the pharmacist unlocks the device 10 with a key 32. The key 32 can be a special design that is not able to be copied or reproduced easily. Any suitable key design known to or conceivable to one of skill in the art can be used. FIG. 3B illustrates removal of the lock mechanism 30 after the key is used to unlock it. FIG. 3C illustrates the loading of pills 34 within the pill cartridges. While loading pills 34 individually is shown in FIG. 3C, it should be noted that pills can be loaded in stacks or by use of a specialized pill loading device. FIG. 3D illustrates the lock mechanism 30 being put back in place and the device 10 being re-secured for use by the patient.

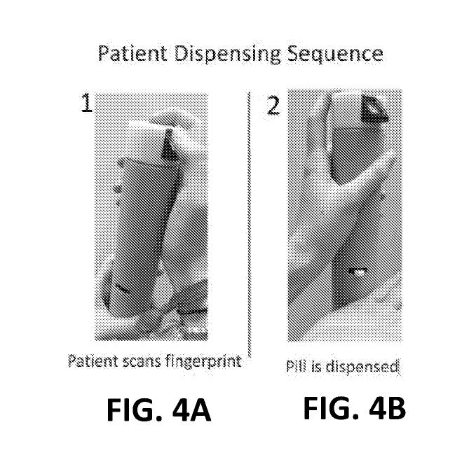

FIGS. 4A and 4B illustrate a patient dispensing sequence for the tamper-resistant, handheld pill dispenser, according to an embodiment of the present invention. FIG. 4A illustrate the patient scanning a fingerprint. FIG. 4B illustrate the pill being dispensed, after the fingerprint is verified. While FIG. 4A illustrates an example of a thumbprint being used to dispense a pill, the device can be set up to open in response to a fingerprint from any of the user's fingers. A delay can also be built in, such that the pill is dispensed a predetermined number of seconds after the scanning of the fingerprint. This delay gives the user time to readjust after scanning the fingerprint, in order to receive the dispensed pill. The device would primarily be for home-use. The device is powered by a standard two-prong outlet with an AC/DC connector positioned on the device. Alternately, the device could also be battery charged, including rechargeable batteries. The device can include a built-in port for recharging. The device should not be considered limited to home-use. As noted above, pharmacist can load pills one-by-one, or using pre-loaded cartridges or pre-stacked configurations of pills for loading multiple pills in shorter time.

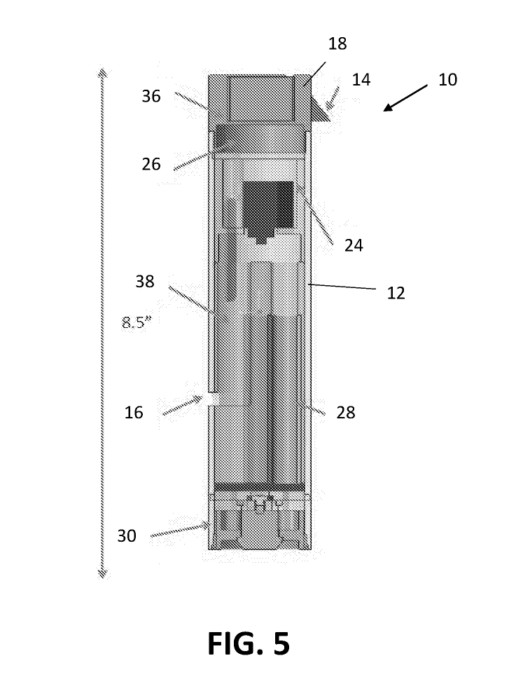

FIG. 5 illustrates a partially sectional view of the tamper-resistant, handheld pill dispenser, according to an embodiment of the present invention. In the embodiment of the device 10 illustrated in FIG. 5, the device includes outer housing 12, in which the other components are disposed. The region for scanning a fingerprint 14 is disposed near a proximal end of the device 10. The region for scanning the fingerprint 14 is surrounded by cap 18. An AC connector 36 can be positioned at the proximal end of the device 10, as well, given the convenient proximity to the electronic components of the device. The steel cap 26 is disposed just below cap 18 in order to provide additional security to the device. Electronic components such as the servo motor, are disposed within the electronics holder 24. Pill cartridges 28 are disposed within the cartridge holder 38. Pills are dispensed through pill dispensing slot 16. Locking mechanism 30 ensures that the pills are secure within the device 10 and that the pill cartridges 28 can only be accessed by a pharmacist with the specialized key for the locking mechanism 30.

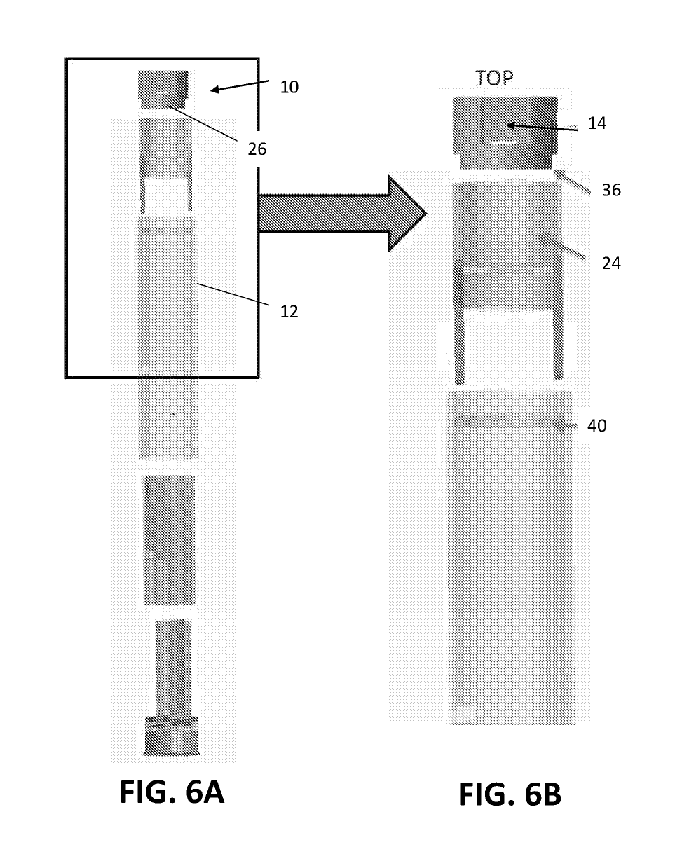

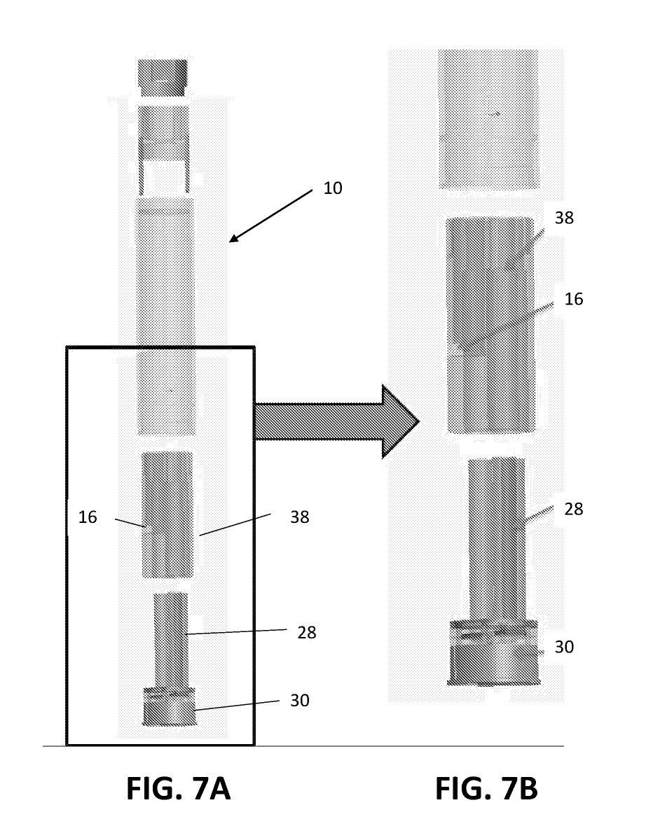

FIGS. 6A, 6B, 7A and 7B illustrate exploded views of the tamper-resistant, handheld pill dispenser, according to an embodiment of the present invention. FIG. 6B illustrates a zoomed in view of the top region of the device and FIG. 7B illustrates a zoomed in view of the bottom region of the device. The device includes outer housing 12, in which the other components are disposed. The region for scanning a fingerprint 14 is disposed near a proximal end of the device 10. The region for scanning the fingerprint 14 is surrounded by cap 18. An AC connector 36 can be positioned at the proximal end of the device 10, as well, given the convenient proximity to the electronic components of the device. The steel cap 26 is disposed just below cap 18 in order to provide additional security to the device. Electronic components such as the servo motor, are disposed within the electronics holder 24. A separation 40 can be provided between the pills and the electronic components in the electronics holder 24. Pill cartridges 28 are disposed within the cartridge holder 38. In some embodiments pills can move through the slots in order to reach the pill dispensing slot 16. Pills are then dispensed through pill dispensing slot 16. Locking mechanism 30 ensures that the pills are secure within the device 10 and that the pill cartridges 28 can only be accessed by a pharmacist with the specialized key for the locking mechanism 30.

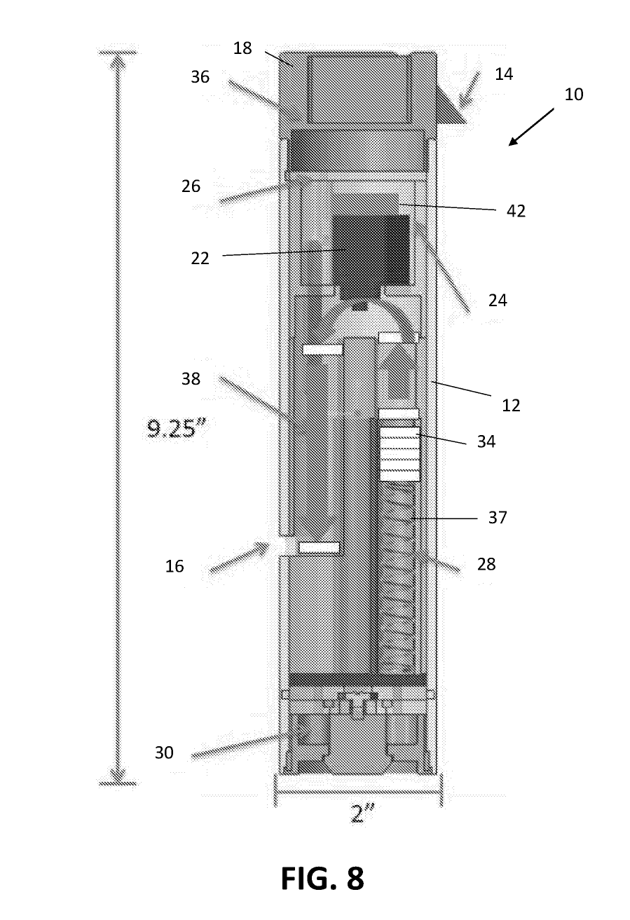

FIG. 8 illustrates a sectional and schematic view of the tamper-resistant, handheld pill dispenser and pill movement through the device, according to an embodiment of the present invention. The region for scanning the fingerprint 14 is coded directly to patient and pharmacist and is held in the housing 12. The device 10 also includes the AC charging port 36. Electronics, such as the servo motor are held within the electronics holder 24. A microcontroller 42 can also be included and disposed within the electronics holder 24 with the servo motor 22. The microcontroller facilitates servo actuation and fingerprint recognition. The device 10 includes the housing 12 which can take the form of a strong outer steel casing. Any other suitable, strong material can also be used. A high strength locking mechanism 30 is included at the base or distal end of the device 10. Steel cap 26 encloses the top of the device 10. Pills 34 are loaded into pill cartridges 28. The pill cartridges 28 can be spring loaded with a spring 37 to arrive at disk and carried with the servo motor 22 to be dispensed at pill dispensing slot 16. The pill cartridges 28 and the pill dispensing slot 16 lie within the cartridge holder 38.

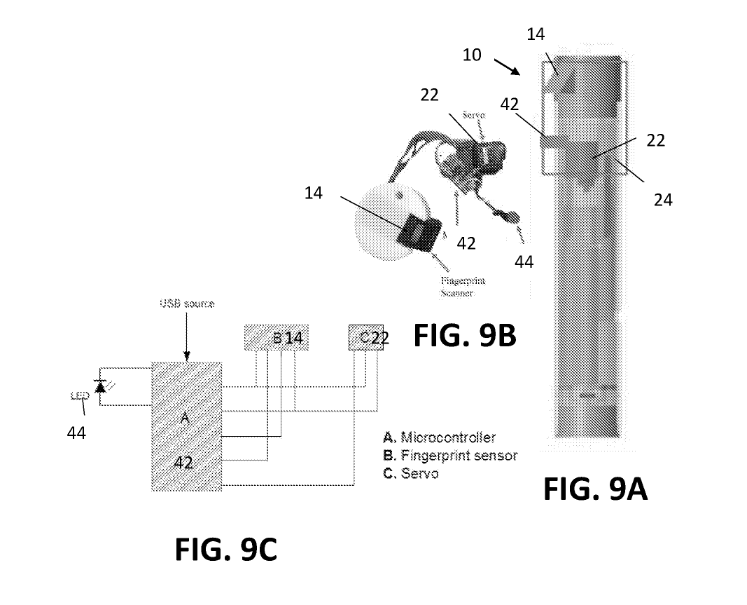

FIG. 9A illustrates a side view of a location of electronics within the tamper-resistant, handheld pill dispenser, according to an embodiment of the present invention, and FIG. 9B illustrates a perspective view of electronics within the tamper-resistant, handheld pill dispenser, according to an embodiment of the present invention. The region for scanning fingerprint 14, the servo motor 22, and the microcontroller 42 are the main electronics of the device 10 and are housed largely within the electronics holder 24. An LED 44 can also be included in some embodiments in order to provide recognition and feedback of enrollment, dispensation of a pill, etc. The LED 44 will light up at these times. The region for scanning fingerprint 14, the servo motor 22, and the microcontroller 42 are all in electronic communication. The LED 44 is in electronic communication with the microcontroller 42.

FIG. 9C illustrates a schematic diagram of electronics within the tamper-resistant, handheld pill dispenser, according to an embodiment of the present invention. As illustrated in FIG. 9C the microcontroller 42 is in electronic communication with the LED, the region for scanning fingerprint 14, and the servo motor 22. The microcontroller 42 receives and transmits information to and from the region for scanning fingerprint 14 and the servo motor 22. The microcontroller 42 transmits information to the LED 44.

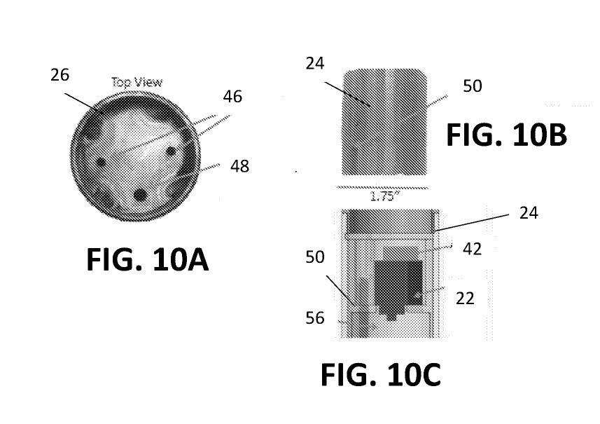

FIGS. 10A-10C illustrate views of a cap and electronics housing for the tamper-resistant, handheld pill dispenser, according to an embodiment of the present invention. The steel cap 26 (preferably 4130 steel), illustrated in FIG. 10A, is positioned on top of the device to increase security. The circular steel fits into the top of the device and can be tack welded in 4 different spots. The steel cap 26 can include screw holes 46 for further securing the cap 26 to the electronics holder 24 and also holes for wires 48 for the electronics. The electronics holder 24 is illustrated in FIG. 10B. The electronics holder 24 includes a platform 50 for the servo motor. FIG. 10C illustrates a sectional view of the electronics holder 24 with electronics within. The servo motor 22 sits on platform 50 and a microcontroller 42 sits near the servo motor 22. Disk 56 is actuated by the servo motor to move the pills.

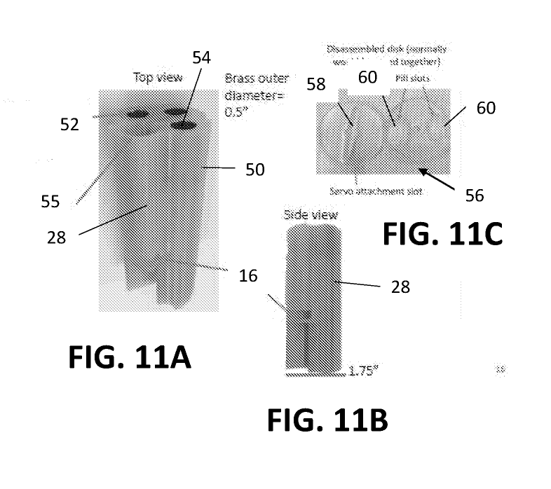

FIGS. 11A-11C illustrate views of pill storage for within the tamper-resistant, handheld pill dispenser, according to an embodiment of the present invention. FIG. 11A illustrates a perspective view of the pill cartridge, FIG. 11B illustrates a side view of the pill cartridge, and FIG. 11C illustrates top down views of the disks for transferring the pills. As illustrated in FIGS. 11A and 11B cartridge inserts 52 can be disposed within pill slots 54. The cartridge inserts 52 can be permanently incorporated into the pill cartridge 28 or can be inserted filled with pills. As illustrated in FIG. 11B, the cartridge inserts 52 are formed from brass, however, any suitable material known to or conceivable to one of skill in the art could be used. One pill slot 54 forms the exit path to the pill dispensing slot 16. The pills are advanced up through the pill slot 54 with the springs discussed earlier and transferred to the pill exit path 55 with the servo motor. Disk 56 is used to transmit the pill from the pill slot 54 to the pill exit path 55. The servo motor is attached to disk 56 via the servo attachment slot 58. Pill disk slots 60 move the pills from the pill slot 54 to the pill exit.

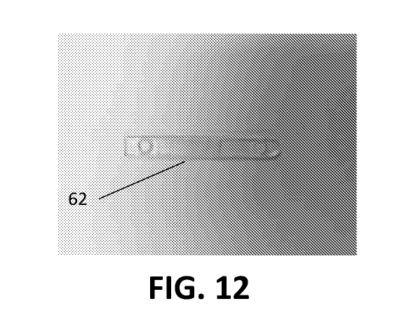

FIG. 12 illustrates a connector, according to an embodiment of the present invention. Connector 62 is used to connect the electronics housing and cartridge holder so that they are mechanically attached and properly oriented. The connector is made out of acrylic and cut using a laser cutter. Any other suitable material and method of manufacture could also be used.

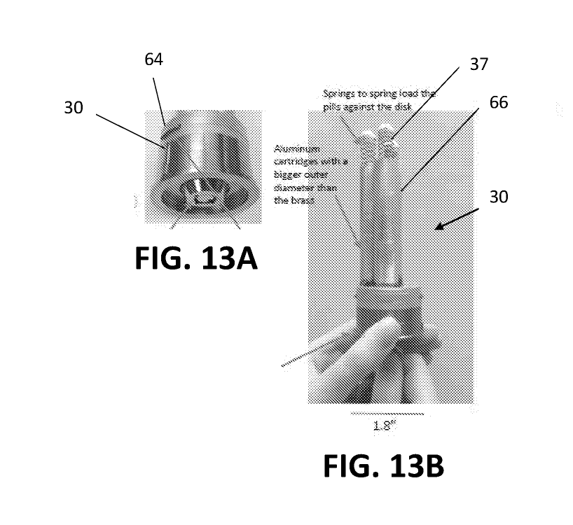

FIGS. 13A and 13B illustrate views of a locking mechanism and a pill dispensation mechanism, according to an embodiment of the present invention. FIG. 13A illustrates a locking mechanism of the device and FIG. 13B illustrates the lock cartridges and springs of the locking mechanism, according to an embodiment of the present invention. With respect to FIG. 13A the locking mechanism 30 receives a specialized key. Turning the key actuates pins 64 that hold the locking mechanism 30 in place and keep the pills secure within. In some embodiments, as illustrated in FIG. 13B the locking bottom 20 can include spring cartridges 66 and springs 37. These cartridges 66 can be configured to slide inside or around the cartridge inserts, described above. This is an added security measure and also facilitates easy loading of pills and reloading of the springs for actuating the pills to the servo motor disk.

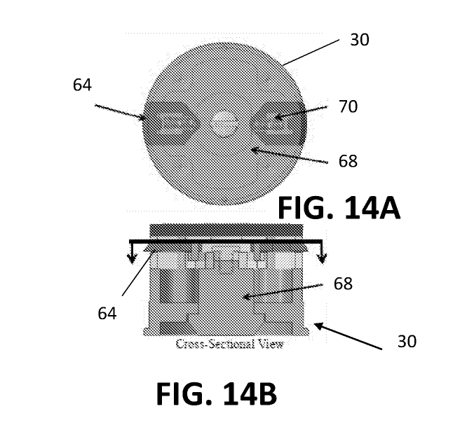

FIGS. 14A and 14B illustrate views of the locking mechanism, according to an embodiment of the present invention. FIG. 14A illustrates a top down view of the locking mechanism 30 and FIG. 14B illustrates a sectional view of the locking mechanism 30. The locking mechanism 30 includes a cam 68 that turns when the key is turned. When the cam 68 is turned, springs 70 are actuated to expand or retract the pins 64.

Any exemplary embodiment of the present invention was tested. These tests and results and the exemplary embodiment used are not to be considered limiting, but are included merely by way of example. In the test, a correct fingerprint was scanned and the pill was dispensed. The device was loaded with 4 pills and all 4 pills were dispensed, one after another. For pharmacist loading, 60 pills were loaded one-by-one. A locking mechanism with springs and cartridges was inserted after the pills were loaded. In some embodiments, a pharmacist can load more than one pill at a time. It is not required for pills to be inserted in a precise orientation, as the cartridges can be sized to allow the pills to reorient themselves as they are loaded. With respect to the security and strength of the device, a tester used hammer, screwdriver, vice, drill, and hack saw for 20 minutes. The test resulted in some denting, but the tester was not able to get pill out of dispenser. The dispenser can be case hardened to resist physical damage or tampering.

Lubricant can be used to facilitate locking and unlocking of locking assembly. Guides can be provided for aiding proper alignment of spring guide with cartridge holder. The pill slot in the disk can be sized to a height minimize the change of a pill jamming. For example, the height of the slot may be sized to approximately the height of the pill. The holes in the electronics housing can be sized and/or threaded for screws (4-40 screws were used in some examples). LED can be provided on or within the fingerprint scanner housing. The device can house a USB cord internally or a port that allows for USB power connection. Cartridges can be sized to fit desired pill dimensionality. Some example devices used brass tubes. However, another material can be used, such as other metals or polymers that can be lighter for weight savings.

In some embodiments, the device can use modular cartridges that allow for different pills and sizes. The device can be configured for a pharmacist to change prescription/dosage control via electronics, either in person or remotely. The device can include an external pill counter for patient. It should be noted that the device is not limited to sizes and configurations shown in the examples. The device can be differently shaped or can be smaller for increased portability and ease of handling. Various materials can be used to reduce overall weight (e.g., cartridges could be changed to lighter material than that used in examples) and size.

The actuation of the present invention can be carried out using a computer, non-transitory computer readable medium, or alternately a computing device or non-transitory computer readable medium incorporated into the device.

A non-transitory computer readable medium is understood to mean any article of manufacture that can be read by a computer. Such non-transitory computer readable media includes, but is not limited to, magnetic media, such as a floppy disk, flexible disk, hard disk, reel-to-reel tape, cartridge tape, cassette tape or cards, optical media such as CD-ROM, writable compact disc, magneto-optical media in disc, tape or card form, and paper media, such as punched cards and paper tape. The computing device can be a special computer designed specifically for this purpose. The computing device can be unique to the present invention and designed specifically to carry out the method of the present invention. It is not a standard business or personal computer that can be purchased at a local store. Additionally, the console computer can carry out communications with the scanner through the execution of proprietary custom built software that is designed and written by the manufacturer for the computer hardware to specifically operate the hardware.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A tamper-resistant, handheld pill dispenser comprising:
a housing including a container defining an interior space sized to hold a plurality of pills, and defining an opening on a side of the housing, the opening being sized sufficiently to deposit the plurality of pills into the container;
a locking assembly disposed in the opening;
a delivery channel sized with dimensions sufficient to pass a pill of the plurality of pills therethrough, the delivery channel arranged to extend from the container to an exterior of the pill dispenser;
a user input device on an exterior of the housing; and
a dispensing mechanism disposed within the pill dispenser adjacent to the container,
wherein the locking assembly is configured to selectively open and close the opening in the housing, and is configured to restrict access to the container through the opening by unauthorized users,
wherein the dispensing mechanism is configured to dispense a pill of the plurality of pills from the container to the exterior of the pill dispenser via the delivery channel, and
wherein the dispensing mechanism is configured to dispense the pill when activated by an authorized user of the pill dispenser.

2. The tamper-resistant, handheld pill dispenser according to claim 1, wherein the container comprises a spring-loaded cartridge configured to hold the plurality of pills.

3. The tamper-resistant, handheld pill dispenser according to claim 1, wherein the dispensing mechanism comprises:
a microcontroller operatively connected to the user input device; and
a motor operatively controlled by the microcontroller and configured to transfer a pill from the container to the delivery channel when activated,
wherein the microcontroller is configured to activate the motor when a predetermined signal is received from the user input device.

4. The tamper-resistant, handheld pill dispenser according to claim 3, wherein the dispensing mechanism further comprises:
a transfer disc coupled to the motor and having a pill-receiving portion sized to at least partially receive a pill to be dispensed, the transfer disc being configured to be rotated by the motor,
wherein the pill to be dispensed is transferred from the container to the delivery channel within the pill-receiving portion as the transfer disc is rotated by the motor.

5. The tamper-resistant, handheld pill dispenser according to claim 3, wherein the user input device is a biometric sensor.

6. The tamper-resistant, handheld pill dispenser according to claim 5, wherein the biometric sensor is a fingerprint scanner.

7. The tamper-resistant, handheld pill dispenser according to claim 1, wherein the pill dispenser is configured to dispense pills in a predetermined dosage when activated by the authorized user.

8. The tamper-resistant, handheld pill dispenser according to claim 1, wherein the dispensing mechanism is configured to not dispense the pill when activated by an unauthorized user of the pill dispenser.

9. The tamper-resistant, handheld pill dispenser according to claim 1, further comprising a light emitting diode (LED).

10. A method of storing pills in a tamper-resistant, handheld pill dispenser, the method comprising:
storing a plurality of pills within a container, the container having an opening for loading the plurality of pills into the container;
restricting access to the opening of the container with a locking assembly;
providing a user input device on an exterior of the pill dispenser; and,
providing a dispensing mechanism configured to receive a signal from the user input device and,
when a predetermined signal is received, to dispense a pill of the plurality of pills from the container to an exterior of the pill dispenser.

11. The method of claim 10 further comprising providing a spring-loaded cartridge configured to hold the pills.

12. The method of claim 10 further comprising:
providing a microcontroller operatively connected to the user input device; and
providing a motor operatively controlled by the microcontroller and configured to transfer a pill from the container to the delivery channel when activated,
wherein the microcontroller is configured to activate the motor when a predetermined signal is received from the user input device.

13. The method of claim 10 further comprising:
providing a transfer disc coupled to the motor and having a pill-receiving portion sized to at least partially receive a pill to be dispensed, the transfer disc being configured to be rotated by the motor,
wherein the pill to be dispensed is transferred from the container to the delivery channel by carried within the pill-receiving portion as the transfer disc is rotated by the motor.

14. The method of claim 10 further comprising providing a biometric sensor as the user input device.

15. The method of claim 14 further comprising providing a fingerprint scanner as the biometric sensor.

16. The method of claim 10 further comprising providing the pill dispenser being configured to dispense pills in a predetermined dosage when activated by the authorized user.

17. The method of claim 10 further comprising not dispensing the pill when activated by an unauthorized user of the pill dispenser.

18. The method of claim 10 further comprising providing an LED for indicating when the pill dispenser is activated.

19. The method of claim 10 further comprising providing a key such that the device can be unlocked by a pharmacy.

20. The method of claim 10 further comprising providing a delay between recognition of a user input and dispensing the pill.
